(19) United States
(12) Patent Application Publication
(10) Pub. No.: US 2003/0084427 A1
(43) Pub. Date: May 1, 2003

(54) Nature emulation oriented programming method

(76) Inventor: Bryan Hunt, Calgary (CA)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 10/013,054

(22) Filed: Oct. 30, 2001

(51) Int. Cl. G06F 9/44

(52) U.S. Cl. 717/116

(57) ABSTRACT

Nature Emulation Oriented Programming (NEOP) uses five categories: Objects, Processors, Critters, Interfaces, and Sets. An object in NEOP differs from an object oriented programming object in that it does not have properties, only private variables. The properties can be considered an interface. Therefore an OOP Object can be considered a NEOP Object plus a NEOP interface. NEOP is patterned after nature. The method includes identifying attributes and scopes of said attributes, functions and scopes of said functions and notifications, for each of machine, critter and interface elements and then determining inherited, needed groupings, and appropriate set relationships between the elements. Finally, at least one startup interface is made, meeting the programming objective.

### BACKGROUND OF THE INVENTION

1. Field of the Invention

This invention relates generally to computer applications software and more particularly to a programming method for emulating nature through a definitional interface and a logical stepwise structured approach.

2. Background and Description of Related Art

In programming with the traditional object oriented approach (OOP) several insufficiencies become apparent. For instance, how does an interface tie-in to an object? Where do processes that act on an object fit, since they cannot be accommodated within the object itself, yet they must be encapsulated somehow? Where would artificial intelligence fit? The present inventive method provides answers to these questions, and more, as it provides an improvement over OOP. OOP lends itself to a single processor wherein improved efficiency and speed requires a faster processor. However, if one looks to nature as a guide, the brain works rather slowly but uses parallel processing to achieve very high processing efficiencies. The present invention is an attempt to provide parallel processing in a computer.

OOP has made programming more organized and grouped ideas together logically. Encapsulation, inheritance, and polymorphism are items of worth in OOP that are carried into nature emulation oriented programming (NEOP).

OOP is an attempt to sanitize programming through improved programming. It has been successful. The main idea of OOP is that common data, called properties, functions related to the data, called methods, and events corresponding to changes in the data should be contained together in one black box or object. Some of this data can be held inexcessibly.

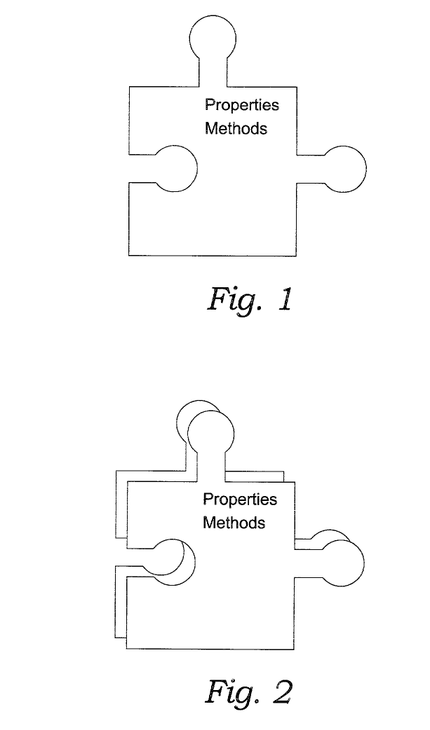

FIG. 1 depicts an object.

This is the idea of encapsulation. For example, one might have a Person object with properties of height, eye color, gender, etc. It would have methods like eat, sleep, run and events like death, birth, and puberty. All this would be contained in one place. Building on this definition, another part of OOP is Inheritance. Inheritance refers to one object building on another. For example, an Employee object may be inherited from the Person object, retaining all its properties and methods, but adding one more: say, salary. This is a method of code reuse. A final part of the OOP approach is polymorphism. Polymorphism defines that many objects may have the same methods. For example, a Person object could have a Sleep method and so could a Dog object. Along with the concept of the object is the concept of a grouping of objects. This is traditionally called a collection. A collection may be an implementation of a grouping of objects (Linked List, Array, Tree, etc) and may in fact have its own properties, methods, and events corresponding to the grouping.

FIG. 2 defines a Collection.

Most OOP programmers like the fact that designs may be made cleanly with objects, however, when a UI is added, it degrades the design. A UI is necessary, however, so this is a failure of the OOP system.

Operations: Operations are usually included with objects. For example in making a number object a (+) operator would be included. This is conceptually the wrong place to put it. It does not belong with a number, but with a group of numbers. One doesn't have number X and add number Y to it. Rather it is desired that X+Y return a new number Z as there may be future uses for X and Y in further equations. A parallel to this would be people objects. One would want Person X <procreates with> Person Y to produce a new offspring: Person Z.

Prior to OOP, the traditional programming methodology revolved around Input leading to Processing, leading to Output. This still happens in modem programs but on a smaller scale. Conceptually, an object should reflect a lifeless thing and not a processing machine. So how do we define these micro-processing objects?

Artificial Intelligence (AI) is used somewhat infrequently in modem software, although its uses are staggering. The reason is that it is not conceptually correct to put this functionality in an object. An object should be concerned with its internal workings only and never with the external world. Many applications of Al need to be concerned with pieces of the external world. How do we correctly model these AI components?

Parallel Processing: The OOP model lends itself nicely to traditional processing and event processing and even multi threaded processing. This is fine, but to truly create efficient software, one must look to parallel processing. What sort of constructs will be needed to ease the work of parallel processing?

Roles: Traditionally properties and methods in objects have three levels of security Public, Private, and Friend. What happens in a large-scale application where there sire many users with many different roles. How do we define which roles can see which object information? It would be preferable to have a different GUI for each role for each object so that when each screen is built for a user, he would see only what he had access to without any intelligence within the screens, for example.

The following art defines the present state of this field:

Imamura, U.S. Pat. No. 5,560,014 describes a programming interface for converting network management application programs written in an object-oriented language into network communication protocols. The application programs manipulate managed objects specified according to GDMO/ASN.1 ISO standards. Methods are provided for mapping from GDMO template and ASN.1 defined types into C++ programming language. The interface has both an object interface composing means for generating code which provides proxy managed object classes as local representatives for managed object classes, and a run time system means for providing proxy agent object classes as representative for remote agents.

David et al., U.S. Pat. No. 5,872,937 describes a method and system for creating named relations between classes in a dynamic object-oriented programming environment via mappers. The mapping objects dynamically bind to the class interfaces of the classes being related. These connections between classes are defined within a visual environment. The relationships can be programmatically attached by name to object instances during program execution. Because these relationships are stored in a resource and are dynamically bound by name to the objects, they can be created and modified without requiring the source code of the objects being associated to be changed. This eliminates hard coded dependencies between objects that impede reuse of the objects in other contexts. The invention requires and takes full advantage of, meta-data, full dynamic binding and probing support in the objects being connected with the invention.

Hales et al., U.S. Pat. No. 6,111,216 describes a process control optimization system which utilizes an adaptive optimization software system comprising goal seeking intelligent software objects; the goal seeking intelligent software objects further comprise internal software objects which include expert system objects, adaptive models objects, optimizer objects, predictor objects, sensor objects, and communication translation objects. The goal seeking intelligent software objects can be arranged in a hierarchical relationship whereby the goal seeking behavior of each intelligent software object can be modified by goal seeking intelligent software objects higher in the hierarchical structure. The goal seeking intelligent software objects can also be arranged in a relationship, which representationally corresponds to the controlled process' flow of materials or data.

Brumme et al., U.S. Pat. No. 6,134,559 describes a uniform object model integrated objects defined by foreign type systems into a single integrating object oriented system. The type system for the integrated object oriented system supports a superset of features from foreign object systems. The uniform object model approach converts foreign objects into uniform object model objects defined by the integrated type system and layers onto the uniform object model objects additional members supported by the integrated type system. Adapters integrate foreign objects and data sources into the integrated object oriented system by implementing foreign objects as full-fledged objects of the system. The foreign object adapters are bi-directional such that objects, registered in the system, are exposed to foreign object systems. During run time, clients obtain a connection to the data source adapter, which supports the target data source, to execute transactions in the target data source. When executing transactions in the target data source, the data source adapter operates as an object access mechanism by generating an object populated with data from the target data source. The data source adapters support a single predetermined dialect of a query language, regardless of the target data source, and generate a query statement compatible with the target data source. The data source adapters also support persistence of objects in the data sources.

Ohsuga, U.S. Pat. No. 6,171,109 describes a method of designing an intelligent system assuring autonomy in problem solving to the largest extent. An architecture of a general-purpose problem solving system and also a new modeling scheme for representing an object, which may include human activity, are discussed first. Then a special purpose problem solving system dedicated for a given problem is generated. It is extracted from a general-purpose system using the object model as a template. Several new concepts are included in this disclosure to achieve this goal; a multi-level function structure and its corresponding knowledge structure, multiple meta-level operations, a level manager for building general purpose problem solving systems, a concept of multi-strata model to represent objects including human activity, and a method of extracting a special purpose system from a general purpose system and so on. This idea induces a very different view to computer systems from the conventional ones and systems designed according to this idea extend the scope of computer applications to a large extent, e.g., they can solve problems, which require exploratory operations. In particular, it is important that this idea leads us to the concept of automatic programming instead of the conventional style of using computers.

The prior art teaches the use of straightforward logic oriented programming, but does not teach a method ideally suitable to parallel processing or artificial intelligence The present invention fulfills these needs and provides further related advantages as described in the following summary.

### SUMMARY OF THE INVENTION

The present invention teaches certain benefits in construction and use which give rise to the objectives described below.

Nature Emulation Oriented Programming (NEOP) aims to fix the failures in traditional programming and to provide a fresh methodology. It aims to be the preferred method for creating dynamic, efficient, scalable, software.

A primary objective of the present invention is to provide an apparatus and method of use of such apparatus that provides advantages not taught by the prior art.

Another objective is to provide such an invention capable of emulating the states and processes of nature.

A further objective is to provide such an invention capable of emulating the parallel processing of the higher order brain.

A still further objective is to provide such an invention capable of simple application and ready understanding in its comparison of elements related to well known objects and processes.

Other features and advantages of the present invention will become apparent from the following more detailed description, taken in conjunction with the accompanying drawings, which illustrate, by way of example, the principles of the invention.

### DETAILED DESCRIPTION OF THE INVENTION

The above described drawing figures illustrate the invention in at least one of its preferred embodiments, which is further defined in detail in the following description.

With respect to OOP, NEOP extends its methodology beyond the use of only Objects. NEOP uses five categories: Objects, Machines, Critters, Interfaces, and Sets. An object in NEOP differs from an OOP object in that it does not have properties, only private variables. The properties can be considered an interface. Therefore an OOP Object can be considered a NEOP Object plus a NEOP interface.

NEOP is patterned after nature. Nature demonstrates remarkable efficiency in processing, for instance, in the brain, and as such, it is ideal for modeling the present new software methodology. In modeling a tree with traditional OOP techniques, one may proceed with the following.

Tree

Properties

Branches

Color

Is Evergreen

Methods

Grow

Events

Die

This does not describe chlorophyll interactions or individual leaf health, root patterns, symbiotic organisms living in the tree, etc. With NEOP, one may better pattern nature, and in so doing, create more efficient software. A NEOP tree example is shown below.

Definitions:

In order to describe NEOP items, some definitions are necessary. This document will refer to items as Introverts, Extroverts, Processing, or Non-Processing. For the purposes of this document, they will be defined as follows.

Introvert: An item is considered an introvert if it is solely concerned with what is contained within it. A traditional OOP object would be considered an introvert.

Extrovert: An item is considered an extrovert if it is concerned with things that are external to itself as well as those within itself. A GUI can be considered an example of an extrovert as it is concerned with user interaction as well as its elements.

Processing: An item is considered a processor if its sole reason for being is to manage something, to execute data, to monitor events, etc. A meat grinder is an example of a processing item.

Non-Processing: An item is non-processing if it is not involved in processing. It is concerned with handling its own data or simply just maintaining its state. A traditional OOP object or a GUI would both be considered non-processing.

NEOP items may be defined as follows:

| | Introvert | Extrovert |
|---|---|---|
| Processing | Machine | Critter |
| Non-Processing | Object | Interface |

Object: An object is a thing. It is a brick, or a bank transaction, etc.

Attributes:

Variables: Variables of the object. These can be made public via an interface.

Methods: Things that can be done to the object.

Events: Things happening with the object.

Group: A group of objects is called a Collection,

Interface: An interface is an interaction of the object. It is a GUI window to the object, or strictly a group of data visible from one object to another. Most objects need a default interface.

Attributes:

Elements: Pieces of the interface

Methods: Things you can do from the interface

Events: Notifications from the interface

Role: Which roles are allowed to see this interface-Standard OOP roles include Public and Friend.

Group: A group of interfaces is called a Wardrobe.

Machine: A machine is an item that does internal processing. It is given one or more inputs and with this it produces one or more outputs. This is done on a small object level scale and not generally on a large application scale. An example of a machine is a meat grinder, an electric motor, a software object to total up bank transactions, etc. A numeric operator may also be considered a machine.

Attributes:

Input(s): The items the machine will do processing on.

Output(s): The items the machine has created from processing. These may be the same as the inputted items.

Process: What the machine does to the inputs.

Events: Actions that happen in the machine, i.e., identify a full queue.

Group: A group of machines will be known as a factory. Since these are processing on the small “object” scale, the processing can be done on many processors utilizing peer to peer networking and parallel processing. Thus it may be said that a factory can span many processors.

Critter: A critter is an intelligent operator. It usually has some modicum of intelligence or artificial intelligence. A person operating a machine may be considered a critter. In software terms, you may use a critter to monitor load balancing on a network, or operate an enemy plane in a flight simulator, etc.

Attributes:

HeartBeat: A critter must have a rate at which it does its processing.

Action: The action a critter performs.

Events: States of the critter such as idle and active.

Group: A group of critters are known as a colony. Colonies can also span processors and work in a parallel fashion.

Set: It was mentioned before that a traditional OOP object was actually a NEOP object and a NEOP interface. A method is needed to group the object and the interface together. This is known as a Set. Therefore, a Person object along with a public Person interface would be known as a Person set. Another example of a set is a math object for numbers. A Number Set includes a number object, a number interface(s), a number collection, and a few number machines (operators). Sets produce a need for another type of scope, in addition to Public, Private and Friend, and this is called Family. The Family scope allows a property or method to be accessed by other members of the Set. Each of these NEOP items still uses the concepts of encapsulation, polymorphism, and inheritance.

The NEOP method may be described as follows:

1. Examine the requirements for the desired software

2. Divide pieces of the software into different categories (Objects, Interfaces, Machines, and Critters) depending on what it does. If it is simply data and methods on that data, it is an object. If it is a way of displaying or sharing data it is an interface. If it is something that processes data into new data, it is a machine. If it is a controller, it is a critter.

3. For each object, do the following:

3.1. Isolate which variables (attributes) the object has and their scope (public, private, and friend)

3.2. Isolate which methods (functions) the object has and their scope (public, private, and friend).

3.3. Isolate which events (notifications) the object has.

3.4. Break the object into sub objects if necessary. For example, a person object may contain two eye objects instead of containing all eye properties and methods. This stop is sometimes called creating an object hierarchy.

3.5. Isolate if it has any associated processes (machines), This can be flushed out with step 4.

3.6. Isolate if it has any associated artificial intelligence (critters). This can be flushed out with step 5.

3.7. Isolate any needed interfaces. This can be flushed out in step 6.

4. For each Machine, do the following:

4.1. Isolate what its inputs and outputs will be needed.

4.2. Isolate how this machine will process its data.

4.3. Isolate what its events (notifications) will be.

4.4. Isolate if it has any operational variables and methods. This will be an internal object and can be flushed out with step 3.

4.5. Isolate if it has any associated artificial intelligence (critters). This can be flushed out with step 5.

4.6. Isolate any needed interfaces. This can be flushed out with step 6.

5. For each Critter, do the following:

5.1. Isolate the action that the critter takes. What does it work with? What does it control? This step could involve creating some software involving artificial intelligence.

5.2. Isolate the heartbeat, or how frequently the critter acts on its domain.

5.3. Isolate if it has any associated objects. This can be flushed out with step 3.

5.4. Isolate if it has any associated processes (machines), This can be flushed out with step 4.

5.5. Isolate any needed interfaces. This can be flushed out with step 6.

6. For each Interface, do the following:

6.1. Isolate all elements available to the interface. This may include simple properties available or it may include user interface elements such as text boxes or pictures.

6.2. Isolate all roles allowed for this interface. This will ensure that only users with certain roles will see the appropriate information.

6.3. Isolate all methods available at the interface.

6.4. Isolate all events that will come from the user interface. This will detail how it will interact with underlying objects, machines, or critters.

6.5. Isolate any associated objects. This can be flushed out with step 3.

6.6. Isolate any associated processes. This can be flushed out with step 4.

6.7. Isolate any associated artificial intelligence. This can be flushed out with step 5.

7. Determine common methods, properties, events, etc between objects, interfaces, machines, and critters and name them. For example a cheetah object and a wolf object may both have a method for kill. These methods should both be identified with the same name. This step ensures polymorphism.

8. Determine if some objects, interfaces, machines and critters inherit from others. Change the structure to support this. For example, an employee object may contain all the attributes of a person object, plus some others. In this case it should inherit from the person object instead of having redundant data.

9. Determine which groupings of objects, interfaces, machines and critters are needed in the program and create these: Collections, Wardrobes, Factories, Colonies.

10. Determine which groups of objects, interfaces, machines, and critters should be grouped together in sets. For example, a number object should be grouped together in a set with an addition machine, a multiplication machine, a number interface, etc.

11. Set an interface to be the start-up interface. There can be more than one start-up interface if the software will end up being more than one executable.

To exemplify the above, a tree may be emulated by NEOP. Trees themselves can be considered NEOP objects. Photosynthesis is a process of millions of machines on hundreds of leaves, on tens of branches. Each of these machines can be working as a separate processor. The factories of machines would be local to a leaf. The collection of leaves would be local to a branch. The collection of branches would belong to the tree. Tree growth would be a critter at the tree level as a result of a sun interface. Branch growth and leaf placement would be critters at the branch level. Leaf color would give off a visible interface to the life of an individual leaf. In this fashion the whole tree can be emulated. Parts of the tree may die and wither while others will thrive and grow. This is all done in a massively parallel fashion.

It can be seen from the above that the present invention is a programming method comprising the following steps. This description is similar to the above but providing a broader perspective in support of the appending claims in this application. Please note, too, that the word “identifying” is used as a replacement and synonym for the word “isolate” used above.

a) selecting a program objective;

b) creating portions of a program as elements including any of the objects, interfaces, machines, and critters;

c) for each said object element:

c1) identifying attributes and scopes of said attributes;

c2) identifying functions and scopes of said functions;

c3) identifying notifications;

c4) identifying associated said sub-objects;

c5) identifying associated said elements;

d) for each said machine element:

d1) identifying inputs and outputs;

d2) identifying data processing methods;

d3) identifying notifications;

d4) identifying operational variables and operational methods;

d5) identifying associated said elements;

e) for each said critter element:

e1) identifying actions including work associations and control targets;

e2) identifying frequency of acts relative to a critter domain;

e3) identifying associated said elements;

f) for each of the said interfaces elements;

f1) identifying allowable roles;

f2) identifying available methods;

f3) identifying interface events;

f4) identifying associated said elements;

g) determining and naming common methods, properties and interface events between the elements;

h) determining inherited relationships between the elements;

i) determining needed groupings of the elements;

j) determining appropriate sets of the groupings; and

k) determining at least one startup interface meeting the programming objective.

In the above description step (c5) is preferably completed using steps (d), (e) and (f). In the above description step (d5) is preferably completed using steps (c), (e) and (f). In the above description (e3) is preferably completed using steps (c), (d) and (f). In the above description step (f4) is preferably completed using steps (c), (d) and (e).

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A programming method comprising the steps of:
a) selecting a program objective;
b) creating portions of a program as elements including any of: objects, interfaces, machines, and critters;
c) for each said object element:
c2) identifying attributes and scopes of said attributes;
c2) identifying functions and scopes of said functions;
c3) identifying notifications;
c4) identifying associated said sub-objects;
c5) identifying associated said elements;
d) for each said machine element:
d1) identifying inputs and outputs;
d2) identifying data processing methods;
d3) identifying notifications;
d4) identifying operational variables and operational methods;
d5) identifying associated said elements;
e) for each said critter element:
e1) identifying actions including work associations and control targets;
e2) identifying frequency of acts relative to a critter domain;
e3) identifying associated said elements;
f) for each of the said interfaces elements;
f1) identifying allowable roles;
f2) identifying available methods;
f3) identifying interface events;
f4) identifying associated said elements;
g) determining and naming common methods, properties and interface events between the elements;
h) determining inherited relationships between the elements;
i) determining needed groupings of the elements;
j) determining appropriate sets of the groupings; and
k) determining at least one startup interface meeting the programming objective.

2. The method of claim 1 wherein step (c5) is completed using steps (d), (e) and (f).

3. The method of claim 1 wherein step (d5) is completed using steps (c), (e) and (f).

4. The method of claim 1 wherein step (e3) is completed using steps (c), (d) and (f).

5. The method of claim 1 wherein step (f4) is completed using step (c), (e) and (d).
